(19) United States
(12) Patent Application Publication
(10) Pub. No.: US 2025/0330661 A1
(43) Pub. Date: Oct. 23, 2025

(54) METHOD AND APPARATUS FOR INCLUDING METADATA INCLUDING MEDIA SKIP RELATED INFORMATION IN VIDEO TRANSPORT STREAM

(71) Applicant: TVING CO., LTD., Seoul (KR)

(72) Inventors: Seong Cheol JO, Yongin (KR); Gui Yong YOO, Seongnam (KR); In Duk KIM, Anyang (KR)

(21) Appl. No.: 19/254,027

(22) Filed: Jun. 30, 2025

Related U.S. Application Data
(63) Continuation of application No. PCT/KR2023/021834, filed on Dec. 28, 2023.

(30) Foreign Application Priority Data
Dec. 28, 2022 (KR) 10-2022-0187582

(51) Int. Cl. H04N 21/234; H04N 21/239; H04N 21/442; H04N 21/482

(52) U.S. Cl. CPC H04N 21/234; H04N 21/2393; H04N 21/44213; H04N 21/482

(57) ABSTRACT

Disclosed herein are a method and device for including image section skip information in metadata in a video transport stream, and a method for operating a server in a contents streaming system may include receiving image request information from a client device, identifying a video transport stream corresponding to the image request information, and transmitting the video transport stream to the client device, wherein the video transport stream may include metadata including image skip-related information.

### CROSS-REFERENCE TO RELATED APPLICATION

The present application is a Continuation Application based on an International Application PCT/KR2023/021834 filed one Dec. 28, 2023, which claims priority to a Korean patent application 10-2022-0187582, filed Dec. 28, 2022, the entire contents of which are incorporated herein for all purposes by this reference.

### TECHNICAL FIELD

The present disclosure relates to a contents streaming system, and more particularly, to a method and device apparatus for including metadata including image skip-related information in a video transport stream in a contents streaming system.

### BACKGROUND

With the development of various technologies and changes in consumption trends, a great change has occurred in the way content is supplied and consumed. The development of digital technology, computer technology, Internet/communication technology, etc. has blurred the boundaries of the type of content and the subject of production, which has caused a great change in the creation and consumption patterns of content. Platforms have emerged that allow ordinary people to create and distribute content. In addition, ease of access to various contents has been secured, and various options for consumption methods have begun to be provided.

Among these many changes in the content industry, OTT (over the top) services exist. OTT service is a media platform based on Internet and mobile communication, and provides various contents to consumers without equipment such as a separate set-top box beyond existing broadcasting services. The concept of OTT service started by providing movies and television programs in the form of video on demand (VOD), but the OTT service is still expanding, by not only providing content created by OTT service providers but also expanding its scope to mobile platforms.

### SUMMARY

The present disclosure is directed to providing a method and apparatus for including metadata including image skip-related information in a video transport stream in a contents streaming system.

The present disclosure is directed to providing a method and apparatus for including metadata including image section skip information and/or UX guide information in a video transport stream in a contents streaming system.

The present disclosure is directed to providing a method and apparatus for including metadata including image section type information and/or information on each image section type in a video transport stream in a contents streaming system.

The technical problems solved by the present disclosure are not limited to the above technical problems and other technical problems which are not described herein will be clearly understood by a person having ordinary skill in the technical field, to which the present disclosure belongs, from the following description.

According to an embodiment of the present disclosure, a computer-implemented method for operating a server in a contents streaming system may include receiving image request information from a client device, identifying a video transport stream corresponding to the image request information, and transmitting the video transport stream to the client device, and the video transport stream may include metadata including image skip-related information.

According to an embodiment of the present disclosure, the image skip-related information may be included in at least one of an initialization segment (IS) or a media segment (MS) in the video transport stream.

According to an embodiment of the present disclosure, the image skip-related information may include at least one of image section skip information or user experience (UX) guide information, and the image section skip information may include at least one of image section type information indicating a type of an image section or information on each image section type indicating information on a boundary of an image section.

According to an embodiment of the present disclosure, the information on each image section type may include at least one of time information, section duration information, offset information, or data size information, the UX guide information may include information indicating at least one of whether or not to automatically skip an ending, whether or not to automatically skip an opening, whether or not to expose an ending skip button, whether or not to expose a next episode view button, whether or not to expose an opening skip button, or location information of at least one of the ending skip button, the next episode view button, or the opening skip button, and the metadata may further include information indicating at least one of an item display location, an item display time, a display section duration, or a uniform resource locator (url).

According to an embodiment of the present disclosure, the metadata including the image skip-related information may be included in one metadata box among a moov box, a uuid box, a mdat box, a free box, a udta box, a mvhd box, a trak box, a tkhd box, a mdhd box, a hdlr box, a vmhd box, a stsd box, or an avcc box.

According to an embodiment of the present disclosure, the image request information may include only a request for a video transport stream itself, not including a separate request for metadata from the request for the video transport stream.

According to an embodiment of the present disclosure, a computer-implemented method for operating a client device in a contents streaming system may include transmitting image request information to a server, receiving a video transport stream corresponding to the image request information, and processing the video transport stream, and the video transport stream may include metadata including the image skip-related information.

According to an embodiment of the present disclosure, the image skip-related information may be included in at least one of an initialization segment (IS) or a media segment (MS) in the video transport stream.

According to an embodiment of the present disclosure, the image skip-related information may include at least one of image section skip information or user experience (UX) guide information, and the image section skip information may include at least one of image section type information indicating a type of an image section or information on each image section type indicating information on a boundary of an image section.

According to an embodiment of the present disclosure, the information on each image section type may be at least one of time information, section duration information, offset information, or data size information, the UX guide information may include information indicating at least one of whether or not to automatically skip an ending, whether or not to automatically skip an opening, whether or not to expose an ending skip button, whether or not to expose a next episode view button, whether or not to expose an opening skip button, or location information of at least one of the ending skip button, the next episode view button, or the opening skip button, and the metadata may further include information indicating at least one of an item display location, an item display time, a display section duration, or a uniform resource locator (url).

According to an embodiment of the present disclosure, the method for operating the client device may further include identifying the UX guide information and displaying a user interface corresponding to the identified UX guide information on the client device.

According to an embodiment of the present disclosure, the metadata including the image skip-related information may be included in one metadata box among a moov box, a uuid box, a mdat box, a free box, a udta box, an mvhd box, a trak box, a tkhd box, an mdhd box, an hdlr box, a vmhd box, an stsd box, or an avcc box.

According to an embodiment of the present disclosure, the processing of the video transport stream may include identifying the video transport stream, decoding the identified video transport stream, and reproducing the decoded video transport stream.

According to an embodiment of the present disclosure, the method for operating the client device may further include identifying metadata including image section skip information in the video transport stream and skipping an image section corresponding to the image section skip information, the image skip-related information may include at least one of image section skip information or user experience (UX) guide information, and the image section skip information may include at least one of image section type information indicating a type of an image section or information on each image section type indicating information on a boundary of an image section.

According to an embodiment of the present disclosure, the method for operating the client device may further include, while reproducing the video transport stream, automatically skipping a portion of the video transport stream based on the image skip-related information contained in the metadata included.

According to an embodiment of the present disclosure, the method for operating the client device may further include analyzing age information of a user stored in a memory of the client device; and while reproducing the video transport stream, automatically skipping a portion of the video transport stream based on the image skip-related information contained in the metadata included and the age information of the user.

According to an embodiment of the present disclosure, the method for operating the client device may further include analyzing an identifier of a preset to-be-skipped image section type stored in a memory of the client device; and while reproducing the video transport stream, automatically skipping a portion of the video transport stream based on the image skip-related information contained in the metadata included and the identifier of a preset to-be-skipped image section type stored in the memory of the client device.

According to an embodiment of the present disclosure, a device for transmitting a video transport steam in a contents streaming system may include a first receiver configured to receive image request information from a client device, an identifying unit configured to identify a video transport stream corresponding to the image request information, and a first transmitter configured to transmit the video transport stream to the client device, and the video transport stream may include metadata including image skip-related information.

According to an embodiment of the present disclosure, a device for transmitting a video transport steam in a contents streaming system may include a memory configured to store information necessary for operating the device and a processor coupled with the memory, the processor may be configured to receive image request information from a client device, identify a video transport stream corresponding to the image request information, and transmit the video transport stream to the client device, and the video transport stream may include metadata including image skip-related information.

The features briefly summarized above with respect to the present disclosure are merely exemplary aspects of the detailed description of the present disclosure that follows, and do not limit the scope of the present disclosure.

According to the present disclosure, metadata including image skip-related information may be included in a video transport stream in a contents streaming system.

According to the present disclosure, by including metadata including image skip-related information in a video transport stream in a contents streaming system, the image skip-related information may be directly identified without making a request for the image skip-related information to a separate server.

It will be appreciated by persons skilled in the art that that the effects that can be achieved through the present disclosure are not limited to what has been particularly described hereinabove and other advantages not mentioned herein will be clearly understood from the detailed description below.

### BRIEF DESCRIPTION OF THE DRAWINGS

FIG. 1 illustrates a contents streaming system according to an embodiment of the present disclosure.

FIG. 2 illustrates a structure of a client device according to an embodiment of the present disclosure.

FIG. 3 illustrates a structure of a server according to an embodiment of the present disclosure.

FIG. 4 illustrates the concept of a contents streaming service according to an embodiment of the present disclosure.

FIG. 5 illustrates a structure of an initialization segment (IS) according to an embodiment of the present disclosure.

FIG. 6 illustrates a structure of a media segment (MS) according to an embodiment of the present disclosure.

FIG. 7 illustrates a system for receiving a video transport stream including metadata including image skip-related information according to an embodiment of the present disclosure.

FIG. 8 illustrates a transcoding server structure according to an embodiment of the present disclosure.

FIG. 9 illustrates a flowchart of a procedure of transmitting a video transport stream including image section skip information according to an embodiment of the present disclosure.

FIG. 10 illustrates a flowchart of a procedure of receiving a video transport stream including image skip-related information in a client device according to an embodiment of the present disclosure.

FIG. 11 illustrates a flowchart of a procedure of skipping an image section in a client device according to an embodiment of the present disclosure.

FIG. 12 illustrates a structure of a MPEG-4 part 14 (mp4) file according to an embodiment of the present disclosure.

FIG. 13 illustrates a structure of an mp4 file according to another embodiment of the present disclosure.

FIG. 14 illustrates a basic structure of an mp4 file according to an embodiment of the present disclosure.

FIG. 15 illustrates a structure of an mp4 file and boxes according to an embodiment of the present disclosure.

FIG. 16 illustrates one example of a box structure in an mp4 file according to an embodiment of the present disclosure. FIG. 17 illustrates a basic structure of a box according to an embodiment of the present disclosure.

FIG. 18 illustrates a detailed structure of a box according to an embodiment of the present disclosure.

FIG. 19 illustrates a structure of a moov box according to an embodiment of the present disclosure.

FIG. 20 illustrates a structure of a udta box according to an embodiment of the present disclosure.

FIG. 21 illustrates a structure of information according to each image section type in a video transport stream according to an embodiment of the present disclosure.

### DETAILED DESCRIPTION

Hereinafter, embodiments of the present disclosure will be described in detail with reference to the accompanying drawings so that those skilled in the art can easily carry out the present disclosure. However, the present disclosure may be embodied in many different forms and is not limited to the embodiments set forth herein.

In describing the embodiments of the present disclosure, a detailed description of known configurations or functions will be omitted when it may obscure the subject matter of the present disclosure. In the drawings, parts not related to the description of the present disclosure are omitted, and similar reference numerals denote similar parts.

The functional blocks shown in the drawings and described below are only examples of possible implementations. Other functional blocks may be used in other implementations without departing from the spirit and scope of the detailed description. Additionally, although one or more functional blocks of the present disclosure are represented as separate blocks, one or more of the functional blocks of the present disclosure may be a combination of various hardware and software configurations that perform the same function.

In addition, the expression of including certain components is an expression of “open type” and simply indicates that the corresponding components are present, and should not be understood as excluding additional components. Furthermore, when a component is referred to as being “connected” or “coupled” to another component, it should be understood that it may be directly connected or coupled to the other component or intervening components may also be present.

In addition, a singular expression for an object may be understood as a plural expression, unless the context clearly indicates otherwise. In the present disclosure, expressions such as “A or B” or “at least one of A and/or B” may be understood to include all possible combinations of the items listed together. Expressions such as “first”, “second”, and “third” may modify the object regardless of order or importance, and are used only to distinguish one object from other objects of the same kind.

In addition, in the present disclosure, “configured to” may be understood as having the meaning technically equivalent to any one of expressions of “suitable for”, “having the ability to”, “changed to”, “made to”, “capable of” and “designed to” in terms of hardware or software, depending on the situation, and may be replaced with each other.

The present disclosure is to provide a method and device for controlling a video player according to a motion control mode in a contents streaming system. Specifically, a method of manipulating a player with one hand by switching an operation mode of the video player to a motion control mode when the use of two hands is inconvenient will be described. In particular, the present disclosure presents various embodiments with respect to device manipulation for motion control and mode switching to a motion control mode. Here, the term video player may mean a module that performs a function of playing a video. Also, the terms “image” and “video” may be interchangeably used throughout the specification.

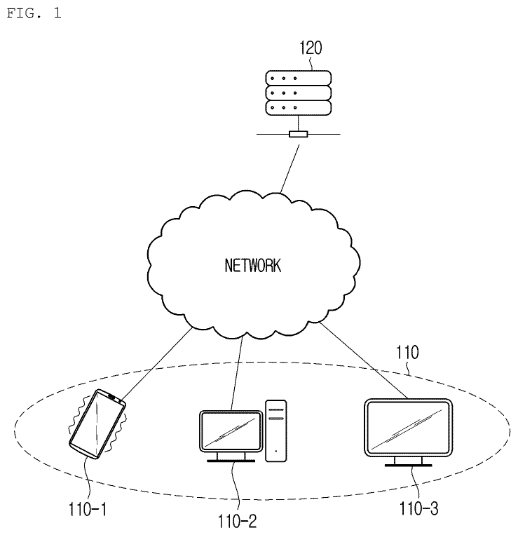

FIG. 1 illustrates a contents streaming system according to an embodiment of the present disclosure. FIG. 1 illustrates a system for providing services related to content, such as content streaming and content-related information provision, and entities belonging to the system. Hereinafter, in the present disclosure, various services related to content may be referred to as ‘content service’ or other terms having equivalent technical meaning.

Referring to FIG. 1, the contents streaming system may include a client device 110 and a server 120. Here, the client device 110 is illustrated as a set of three client devices 110-1 to 110-3, but the contents streaming system may include two or less or four or more client devices. In addition, although one server 120 is illustrated, the contents streaming system may include a plurality of servers that share various functions and interact with each other.

The client device 110 receives and displays content. The client device 110 may receive content streamed from the server 120 after accessing the server 120 through a network. That is, the client device 110 is hardware on which client software or applications designed to use the content service provided by the server 120 are installed, and may interact with the server 120 through the installed software or applications. The client device 110 may be implemented as various types of devices. For example, the client device 110 may be one of a movable portable device, a device that is movable but generally fixed during use, and a device that is fixedly installed at a specific location.

Specifically, the client device 110 may be implemented in the form of at least one of a smartphone 110-1, a desktop computer 110-2, a tablet PC, a laptop PC, a netbook computer, a workstation, a server, a personal data assistant (PDA), a portable multimedia player (PMP), a camera, or a wearable device. Here, the wearable device may be implemented in the form of at least one of an accessory type (e.g., watch, ring, bracelet, anklet, necklace, glasses, contact lens, HMD (head-mounted-device)), clothing type, body attachment type (e.g., skin pad or tattoo), or bio implantable circuit. In addition, the client device 110 may be a home appliance, and may be, for example, implemented in the form of at least one of a television 110-3, a digital video disk (DVD) player, an audio system, a refrigerator, an air conditioner, a vacuum cleaner, an oven, a microwave oven, a washing machine, or an air purifier.

The server 120 performs various functions to provide content services. In other words, the server 120 may utilize these functions to provide services related to content streaming and various types of contents to the client device 110. Specifically, the server 120 may perform datafication to stream content, and transmit the content to the client device 110 through a network. To this end, the server 120 may perform at least one of content encoding, data segmentation, transmission scheduling, or streaming transmission. Additionally, for the convenience of content use, the server 120 may further perform at least one function of providing a content guide, managing a user's account, analyzing a user preference, or recommending content based on preference. A plurality of functions among the various functions described above may be provided, and for this purpose, the server 120 may be implemented as a plurality of servers.

The client device 110 and the server 120 exchange information through a network, and a content service may be provided to the client device 110 based on the exchanged information. In this case, the network may be a single network or a combination of various types of networks. The network may be understood as a form in which different types of networks are connected according to regions. For example, the networks may include at least one of a wireless network or a wired network. Specifically, the networks include a cellular network based on at least one of 6^{th} generation (6G), 5^{th} generation (5G), long term evolution (LTE), LTE Advance (LTE-A), code division multiple access (CDMA), wideband CDMA (WCDMA), and universal mobile telecommunications system (UMTS), wireless broadband (WiMAX), or Global System for Mobile Communications (GSM). Also, the networks may include a local area network based on at least one of a wireless local area network (WLAN), Bluetooth, Zigbee, near field communication (NFC), or ultra wideband (UWB). In addition, the networks may include wired networks such as the Internet and Ethernet.

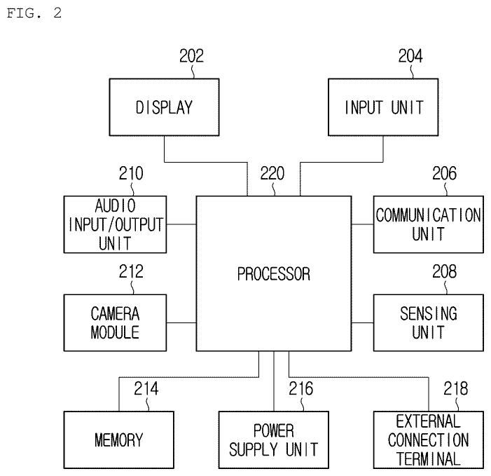

FIG. 2 illustrates a structure of a client device according to an embodiment of the present disclosure. FIG. 2 illustrates a block structure of a client device (e.g., the client device 110 of FIG. 1).

Referring to FIG. 2, the client device includes a display 202, an input unit 204, a communication unit 206, a sensing unit 208, an audio input/output unit 210, a camera module 212, a memory 214, a power supply unit 216, an external connection terminal 218 and a processor 220. However, depending on the type of device, at least one of the components illustrated in FIG. 2 may be omitted.

Each of the display 202, the input unit 204, the communication unit 206, the sensing unit 208, the audio input/output unit 210, the camera module 212, the memory 214, the power supply unit 216, the external connection terminal 218 and the processor 220 may comprise circuitry to perform their functions.

The display 202 outputs information such as visually recognizable images and graphics. To this end, the display 202 may include a panel and a circuit for controlling the panel. For example, the panel may include at least one of a liquid crystal display (LCD), a light emitting diode (LED), a light emitting polymer display (LPD), an organic light emitting diode (OLED), an active matrix organic light emitting diode (AMOLED) or a flexible LED (FLED).

The input unit 204 receives input generated by a user. The input unit 204 may include various types of input sensing units. For example, the input unit 204 may include at least one of a physical button, a keypad or a touch pad. Alternatively, the input unit 204 may include a touch panel. When the input unit 204 includes a touch panel, the input unit 204 and the display 202 may be implemented as one module. The input unit 204 may include a microphone that recognizes the voice of the user and may process, using processing circuitry, the voice to recognize a command. The input unit 204 may be referred to as a user interface.

The communication unit 206 provides an interface for enabling a client device to form a network with other devices and to transmit or receive data through the network. To this end, the communication unit 206 may include a circuit for physically processing signals (e.g., an encoder/decoder, a modulator/demodulator, a radio frequency (RF) front end, etc.), a protocol stack for processing data according to communication standards (e.g., modem), etc. According to various embodiments, the communication unit 206 may include a plurality of modules to support a plurality of different communication standards.

The sensing unit 208 collects sensing data including data on the state of the client device or the surrounding environment. For example, the sensing unit 208 may measure a physical value or a change in value related to an operating state or posture of the client device, and generate an electrical signal representing measured result. In addition, the sensing unit 208 may measure a physical value or a change in value of the surrounding environment of the client device and generate an electrical signal representing the measured result. To this end, the sensing unit 208 may include at least one sensor and a circuit for controlling the at least one sensor. Specifically, the sensing unit 208 may include at least one of a gyro sensor, a magnetic sensor, an acceleration sensor, a grip sensor, a proximity sensor, a color sensor, a bio sensor, an air pressure sensor, a temperature sensor, a humidity sensor, an illuminance sensor, or an ultra violet (UV) sensor, an e-nose sensor, a gesture sensor, an electromyography (EMG) sensor, an electroencephalogram (EEG) sensor, an electrocardiogram (ECG) sensor, an infrared (IR) sensor, an iris sensor, or a fingerprint sensor.

The audio input/output unit 210 outputs sound according to electrical signals generated based on audio data and detects external sound. That is, the audio input/output unit 210 may convert sound and electrical signals into each other. To this end, the audio input/output unit 210 may include at least one of a speaker, a microphone, or a circuit for controlling them.

The camera module 212 collects data for generating images and videos. To this end, the camera module 212 may include at least one of a lens, a lens driving circuit, an image sensor, a flash, or an image processing circuit. The camera module 212 may collect light through the lens and generate data expressing color values and luminance values of light using the image sensor.

The memory 214 may store an operating system, programs, applications, commands, setting information and the like necessary to operate the client device. The memory 214 may temporarily or non-temporarily store data. The memory 214 may include a volatile memory, a non-volatile memory, or a combination of the volatile and non-volatile memory.

The power supply unit 216 supplies power necessary for the operation of components of the client device. To this end, the power supply unit 216 may include a converter circuit that converts power into power with a magnitude required by each component. The power supply unit 216 may depend on an external power source or may include a battery. In the case of including the battery, the power supply unit 216 may further include a circuit for charging. The circuit for charging may support wired charging or wireless charging.

The external connection terminal 218 is a physical connection unit for connecting the client device to another device. For example, the external connection terminal 218 may include at least one of terminals of various standards, such as a universal serial bus (USB) terminal, an audio terminal, a high definition multimedia interface (HDMI) terminal, a recommended standard-232 (RS-232) terminal, an infrared terminal, an optical terminal, or a power terminal.

The processor 220 controls the overall operation of the client device. The processor 220 may control operations of other components and perform various functions using other components. For example, the processor 220 may also request content data from the server and receive the content data through the communication unit 206. Also, the processor 220 may restore content by decoding the received content data. Also, the processor 220 may output content received from the server through the display 202 and the audio input/output unit 210. In addition, the processor 220 may control a state related to reproduction of content based on information input or sensed by at least one of the input unit 204, the communication unit 206, the sensing unit 208, the audio input/output unit 210, the camera module 212, the power supply unit 216, and the external connection terminal 218. To this end, the processor 220 may include at least one of at least one processor, at least one microprocessor, or at least one digital signal processor (DSP). In particular, the processor 220 may control other components and perform necessary operations so that the client device operates according to various embodiments described below.

In the structure of the client device described with reference to FIG. 2, all components are illustrated as being directly or indirectly connected to the processor 220. Although not shown in FIG. 2, at least some of the components may be connected through a bus. In this case, under the control of the processor 220, direct data exchange may be made between some components.

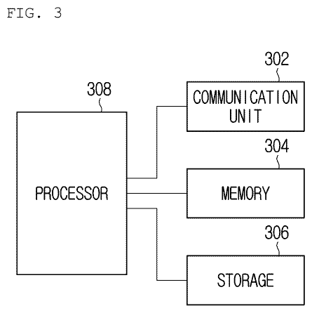

FIG. 3 illustrates a structure of a server according to an embodiment of the present disclosure. FIG. 3 exemplifies a block structure of a server (the server 120 of FIG. 1).

Referring to FIG. 3, the server includes a communication unit 302, a memory 304, a storage 306, and a processor 308. However, according to various embodiments, at least one of the components illustrates in FIG. 3 may be omitted.

Each of the communication unit 302, the memory 304, the storage 306, and the processor 308 may comprise circuitry to perform their functions.

The communication unit 302 provides an interface for communication of the server with another device. To this end, the communication unit 302 may include a circuit that generates and analyzes a physical signal for communication. The interface provided by the communication unit 302 may support wired communication or wireless communication.

The memory 304 may store various types of information, an order and/or information and load a computer program, an instruction, and the like stored in the storage 306. The memory 304 may temporarily store data and an instruction for an operation of the server and include a random access memory (RAM). Alternatively, the memory 304 may include various storage media.

The storage 306 may non-temporarily store an operation system for operating the server, a program for performing a function of the server, setting information for an operation of the server, and the like. For example, the storage 306 may include at least one of a non-volatile memory such as a read only memory (ROM), an erasable programmable ROM (EPROM), an electrically erasable programmable ROM (EEPROM), and a flash memory, a hard disk, a removable disc, a solid state drive (SSD), or any form of computer-readable recording medium widely known in the art to which the present disclosure belongs.

The processor 308 controls an overall operation of the server. The processor 308 may control operations of other components and perform various functions using other components. The processor 308 may include at least one of a central processing unit (CPU), a micro processor unit (MPU), a micro controller unit (MCU), or a well-known form of processor in the art to which the present disclosure belongs. Particularly, the processor 308 may control other components to enable the server to operate according to various embodiments described below and perform a necessary operation.

In a structure of a server described with reference to FIG. 3, components are exemplified to be all directly or indirectly connected to the processor 308. Although not illustrated in FIG. 3, at least a part of the components may be connected through a bus. In this case, according to control of the processor 308, direct data exchange among some components may be made.

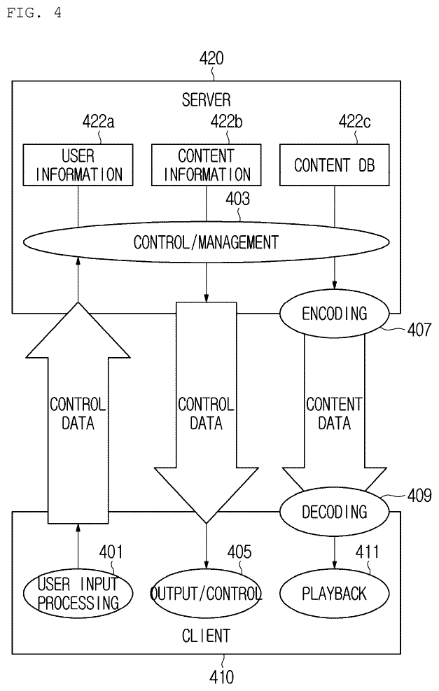

FIG. 4 illustrates a concept of a content streaming service according to an embodiment of the present disclosure. FIG. 4 is a schematic diagram of some functions related to content streaming, and a content streaming service according to various embodiments may have various other functions in addition to the functions illustrated in FIG. 4.

Referring to FIG. 4, control data and content data may be transmitted and received between the client 410 and the server 420. The client 410 may be a client device 110 and the server 420 may be a server 120 according to FIGS. 1, 2 and 3. Specifically, transmission of control data from the client 410 to the server 420, transmission of control data from the server 420 to the client 410, and transmission of content data from the server 420 to the client 410 may be performed.

The server 420 may store user information 422a, content information 422b, and content database (DB) 422c. The user information 422a may include user account information, service use history information of users, information about user preferences, and the like. The content information 422b may include a list of serviceable content, content guide information, content meta information, and content consumption history information. The content DB 422c may include content stored in the form of data. In addition to this, the server 420 may further store other information required to provide services.

Control data transmitted from the client 410 to the server 420 may include information on user log-in, information on content selection by the user, information on control of content by the user, and the like. To this end, the client 410 may generate control data from user input through a user input processing operation 401 and transmit it. Control data from the client 410 may be processed through a control/management operation 403 and used to provide content. For example, the server 420 may perform the control/management operation 403 to receive and process the control data and select and control content based on the control data. In addition, the server 420 may perform the control/management operation 403 to determine preference by analyzing consumption history and behavior of the user, and select content to be recommended according to the determined preference.

A procedure for providing content to a user will be described with reference to FIG. 4 as follows. First, the client 410 generates control data including log-in information (e.g., ID and password) input by a user through the user input processing operation 301 and transmits the control data. The server 420 determines whether the user is valid by searching the user information 422a for log-in information included in the control data from the client 410, and determines the range of content and services allowed according to the user's authority. However, the transmission and processing of log-in information may be omitted if log-in is not required or limited services that may be provided without log-in are supported.

Subsequently, the server 410 may extract content guide information from the content information 422b through the control/management operation 403 and transmits control data including the content guide information to the client 410.

The control data transmitted from the client 410 and the control data transmitted from the server 420 generally refer to data that are used for controlling operations of the server 420 and/or the client 410 and may be different from the other.

The client 410 may output the content guide information included in the control data and confirm user's selection (e.g., receives user's input for selection of a specific content). The user's selection is transmitted to the server 410 as control data via the user input processing operation 401. Information about the user's selection is processed by the control/management operation 403 and used for selection of content to be streamed. The server 420 searches the content DB 422 for the selected content, compresses and segments the searched content through an encoding operation 407, and transmits content data. The content data may be compressed in advance through the encoding operation 407 and stored. Here, the encoding operation 407 may include not only an operation of compressing an original content image, but also an operation of decoding and then re-compressing content data generated through compression. In this case, compression may be performed based on the resolution, bitrate, and number of frames per second of the content image. When it is compressed and stored in advance, the compression operation may be omitted, and the server 420 may perform segmentation on the content data. The content data may be restored through a decoding operation 409 and provided to the client 410 through a playback operation 411. At this time, at least one of various video codecs or various audio codecs may be used for compression and decoding. For example, various video codecs include at least one of Moving Picture Experts Group-2 (MPEG-2), H.264 Advanced Video Coding (AVC), H.265 High Efficiency Video Coding (HEVC), H.266 Versatile video coding (VVC), VP8 (Video Processor 8), VP9 (Video Processor 9), AV1 (AOMedia Video 1), DivX, Xvid, VC-1, or Daala.

The audio codecs may include MP3 (MPEG 1 Audio Layer 3), AC3 (Dolby Digital AC-3), E-AC3 (Enhanced AC-3), AAC (Advanced Audio Coding, MPEG 2 Audio), FLAC (Free Lossless Audio Codec), HE-AAC (High Efficiency Advanced Audio Coding), OGG Vorbis, OPUS and the like.

A plurality of content data may be generated in advance by compressing a content image according to various resolutions, bitrates, and the number of frames per second of the image. The client 410 may measure throughput (or bandwidth) and determine a bitrate based on the measured throughput (or bandwidth).

The client 410 may receive information about a plurality of content data from the server 420. The received information may include information representing the bitrate, resolution, number of frames per second, and location of a plurality of content data.

The client 410 may determine at least one of content data based on the bitrate, and determine content data to be reproduced corresponding to the resolution and number of frames per second that may be reproduced among the at least one content data based on the capability information of the client 410, and its location. In this case, the capability information may include the maximum support resolution and the maximum number of supported frames of the client 410, but is not limited thereto.

The client 410 may transmit a content request to the server 420 based on the location of content data to be reproduced. The server 420 may transmit content data corresponding to the content request to the client 410 based on the received content request.

According to another embodiment, the client 410 may receive user input related to at least one of the resolution or number of frames per second of the image, determine the content data to be reproduced and its location according to the user input, and transmit the content request to the server 420.

The present disclosure relates to a method for including metadata including image skip-related information in a video transport stream in a contents streaming system. Particularly, in the present disclosure, by including image skip-related information in a video transport stream itself, it is possible to identify image skip-related information without requesting separate image skip-related information to a separate server (e.g., application programming interface (API) server). Herein, the image skip-related information may include information for identifying a specific section in an image, but the present disclosure is not limited thereto.

The present disclosure may include image skip-related information in metadata by using a data communication standard (e.g., transport standard) such as HTTP Live Streaming (HLS) and MPEG-Dynamic Adaptive Streaming over HTTP (MPEG-DASH). Especially, because MPEG-DASH is dynamic adaptive streaming through a hypertext transfer protocol (HTTP) and thus is based on an HTTP, every content server (e.g., original content server) may be set to provide a MPEG-DASH stream.

MPEG-DASH may operate by dividing an image into segments and encoding the segments at various quality levels. Specifically, an content server may divide an image file into segments with a length of several seconds and encode the segments. When a client starts to see the image, the encoded segments may be transmitted to a client device through the Internet. The client device may receive the encoded segments and reproduce the image by decoding the segments. Herein, the segments may be further divided into initialization segments (ISs) and media segments (MSs). An MS may convey actual image information, and an IS may contain information necessary for decoding a sequence of MSs conveying the actual image information. Image skip-related information may be included in a metadata form within an IS and/or an MS. In the present disclosure, IS may be referred to as ‘first segment’, ‘initial segment’, or other terms with an equivalent technical meaning.

FIG. 5 illustrates a structure of an IS (i.e., initialization segment) according to an embodiment of the present disclosure. In an IS 510, there may be a ftyp box 520, a moov box 530, and an mdat box 540. The ftyp box 520 may be a file type box that identifies compatibility of a file. The moov box 530 may be a movie box that stores all the metadata of media. The mdat box 540 may be a media data box that stores actual media. Herein, the moov box 530 may include sub-boxes, each including a variety of information. Specifically, the moov box 530 may include an mvhd box 531 and/or one or more trak boxes 532. The mvhd box 531 may be a movie header box including movie information. The trak box 532 may be a track box that defines a single track in a movie. Each box in the IS 510 may include metadata including image skip-related information.

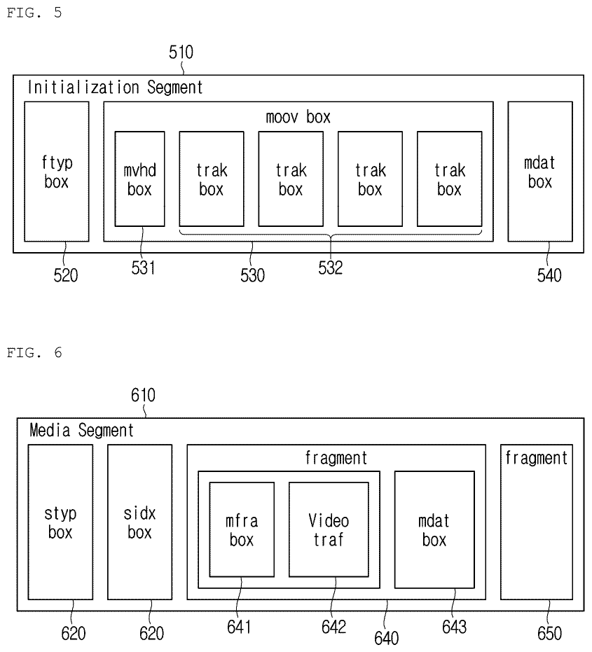

FIG. 6 illustrates a structure of an MS (i.e., media segment) according to an embodiment of the present disclosure. In an MS 610, there may be a styp box 620, a sidx box 630, and fragments 640 and 650. The styp box 620 may be a segment type box including information on a transmitted segment. The sidx box 630 may be a segment index box including segment identifier information. The fragments 640 and 650 may include various boxes including a variety of information. For example, an mfra box 641, a video traf box 642, and an mdat box 643 may be included in a fragment, but the present disclosure is not limited thereto. Each box in the MS 610 may include metadata including image skip-related information. For example, the video skip-related information may be included in, but is not limited to: (i) an emsg box within a media segment based on MPEG-DASH, or (ii) a TXXX frame, which includes a user-defined text information, within an ID3 block in a media segment based on HLS.

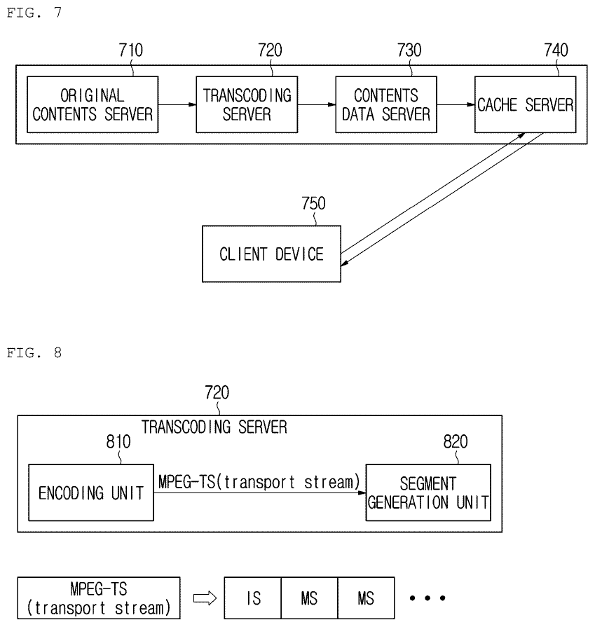

FIG. 7 illustrates a system for receiving a video transport stream with metadata including image skip-related information according to an embodiment of the present disclosure. A system according to the present disclosure may be composed of an original contents server 710, a transcoding server 720, a contents data server 730, and a cache server 740. Each of the original contents server 710, a transcoding server 720, contents data server 730, and the cache server 740 may have a similar structures and configurations to server 120 according to FIGS. 1 and 3.

Referring to FIG. 7, the original contents server 710 may transmit a transport stream of an original image to the transcoding server 720. Herein, the transport stream of the original image may be an image that is already encoded, but may not be limited thereto and be an image that is not encoded.

The transcoding server 720, which receives the transport stream of the original image, may performing transcoding the received transport stream of the original image. Transcoding means a work of transforming a transport stream of an original image. When an original image is not an encoded image, transcoding may include an encoding operation. When an original image is an image that is already encoded, it may include an operation of encoding after decoding. Specifically, transcoding may be a work of improving compatibility with another device by modifying parameters of a source bitstream such as a codec, a resolution, and a bit rate. The contents data server 730 may store an image that is transcoded in the transcoding server 720.

The contents data server 730 may store the transcoded image received from the transcoding server 720 and transmit the stored image to the cache server 740. Herein, the cache server 740 may be a server that is physically located relatively near to the user and temporarily stores data at a site near a user and quickly provides the data in order to improve the Internet service speed. In case a server (e.g., the contents data server 730) is in a distance far from the user such as in a foreign country, the cache server 740 may reduce a fee for use of a circuit necessary for communicating with the foreign country. For example, the cache server 740 may include a cache server of a contents delivery network (CDN).

In case a user initially requests a content once, traffic may occur between the client device 750 and a main server (e.g., the contents data server 730), and contents may be stored (that is, cached) in the cache server 740. Then, when the user of the client device 750 requests a content, contents traffic occurs between the client device 750 and the cache server 740.

A user requests a content to the cache server 740 by using a client device 750, and if the cache server 740 has no content, a cache miss may occur. In this case, the cache server 740 may request the content to the contents data server 730 and receive a response containing the content from the contents data server 730. Then, the cache server 740 may transmit a response containing the content to the user.

A user requests a content to the cache server 740 by using the client device 750, and if the cache server 740 has the content, a cache hit may occur. In this case, the cache server 740 may immediately transmit a response containing the content to the user.

According to an embodiment of the present disclosure, when receiving image request information from the client device 750, the cache server 740 may deliver image data stored therein (hereinafter, ‘video transport stream’) to the client device 750. Herein, the video transport stream itself may include metadata containing image skip-related information. Image skip-related information may include image section skip information and/or user experience (UX) guide information. In addition, image section skip information may include image section type information and/or information on each image section type, but the present disclosure is not limited thereto. Image section type information may include information indicating a type of an image section. In addition, information on each image section type may include information on a boundary of an image section.

The image section skip information may include, as position information of the image section, a time position, a frame position, and/or a data position, etc. The image skip-related information may include, as offset information of the image section, a time interval which is a distance from a start position and/or an end position of the image to a start point and/or an end point of each image section, the number of frames, and/or a data size, etc. The form of the image skip-related information is not limited to the examples described above, and may be implemented as various forms of information capable of identifying the image section.

The image section type may include an intro, a teaser, a prologue, an opening, a synopsis, a main part, a bridge, a summary, an epilogue, an ending, and/or an outro. The image section type is not limited thereto, and the image section type may include various types from which scenes within the image may be distinguished, such as a sexually suggestive scene, a violent scene, a horror-inducing scene, an anxiety-inducing scene, a drug-depicting scene, a drinking-depicting scene, a swearing scene, a scene that induces negative emotions, a scene that undermines moral values, an advertisement scene, and/or a commercial scene. If the image section type is not specifically limited below, the image section type may be interpreted as including various types described above. Each image frame may be categorized into or assigned to one of the image section type above.

According to the present disclosure, the metadata includes image skip-related information in a video transport stream itself, allowing to skip an image section s without requesting image skip-related information to a separate server. In the present disclosure, ‘image section skip information’ may also be referred to as ‘skip information’ or another term with an equivalent technical meaning.

FIG. 8 illustrates a transcoding server structure according to an embodiment of the present disclosure. The transcoding server 720 may include an encoding unit 810 and/or a segment generation unit 820. Each of the encoding unit 810 and the segment generation unit 820 may be in designated hardware circuitry or a software module, or a combination of them, to perform its function.

The encoding unit 810 may encode a transport stream of an original image received from the original contents server 710 in a specific format. Data encoded by the encoding unit 810 may be included in an MPEG-Transport Stream (TS) or a fragmented MP4 (fMP4), which is a container format for transport, and be transmitted to the segment generation unit 820. The segment generation unit 820 may split the transmitted data in time units, make metadata (m3u8 file as a playlist file or mpd file as a manifest file) with a TS file (or fMP4 file) and/or information on a TS file (or fMP4 file), and transmit the metadata to the contents data server 730. Herein, the TS file may be a standard digital container format for transmitting audio, video, and program and system information protocol (PSIP) data. That is, it may be a transport container format for transmitting digital media. In addition, the TS file may be composed of a plurality of segments. For example, the TS file may be composed of an IS and/or a plurality of MSs. As digital media should be transmitted according to a specific transport specification, the transcoding server 720 may store data according to a specification and transmit the stored data.

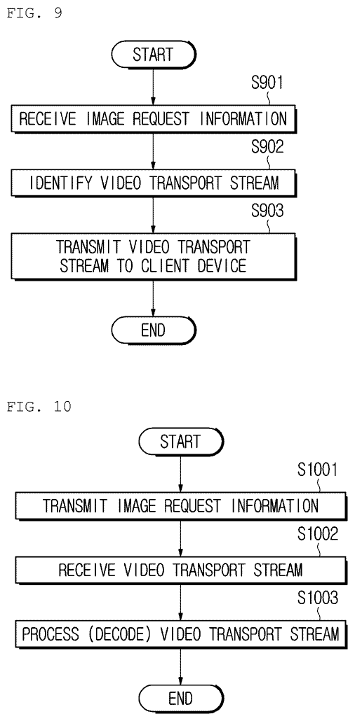

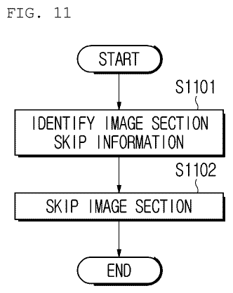

FIG. 9 illustrates a flowchart of a procedure of transmitting a video transport stream including image skip-related information according to an embodiment of the present disclosure. An operating subject of FIG. 9 (i.e., an apparatus that performs the process of FIG. 9) may be a server that stores a video transport stream such as the contents data server 730 and the cache server 740, but the present disclosure is not limited thereto. In the description below, the operating subject of FIG. 9 will be referred to as ‘server’.

Referring to FIG. 9, at step S901, a server may receive image request information. Herein, the image request information may be information received from a client device. The image request information may be a part of the control data described in reference to FIG. 4. The image request information may be received from and transmitted by the client device when and/or while the client device streams an image.

At step S902, the server may identify a video transport stream. That is, it may identify a video transport stream corresponding to the image request information received from the client device. Herein, the video transport stream may include metadata including image skip-related information. The video transport stream may include a metadata box in at least one segment (e.g., IS or MS), and the metadata box may include metadata containing image skip-related information. To this end, the server may include metadata containing the image skip-related information in the video transport stream. Without being limited thereto, metadata including image skip-related information may be included in the video transport stream during the stream encoding and/or transcoding steps.

At step S903, the server may transmit the video transport stream to the client device. At this time, the transmitted video transport stream may include metadata containing image skip-related information. Herein, the image skip-related information included in the transmitted video transport stream may include image section skip information and/or UX guide information. In addition, the image section skip information may include image section type information and/or information on each image section type. To this end, the server may include metadata including image skip-related information in the video transport stream before and/or while transmitting the video transport stream to the client device. Without being limited thereto, metadata including image skip-related information may be included in the video transport stream during the stream encoding and/or transcoding step.

FIG. 10 illustrates a flowchart of a procedure performed by a client device receiving a video transport stream which includes image skip-related information according to an embodiment of the present disclosure. An operating subject of FIG. 10 (i.e., an apparatus that performs the operation of FIG. 10) may be the client device 750. In the description below, the operating subject of FIG. 10 will be referred to as ‘client’ or ‘device’.

Referring to FIG. 10, at step S1001, a device may transmit image request information. The image request information may be a part of the control data described in reference to FIG. 4. The image request information may be transmitted to a sever when and/or while the device streams an image. Herein, the server may be a server storing a video transport stream such as the contents data server 730 and the cache server 740, but the present disclosure is not limited thereto.

At step S1002, the device may receive a video transport stream. That is, the device may receive a video transport stream corresponding to the image request information from the server. The received video transport stream may include metadata containing image skip-related information.

At step S1003, the device may process the video transport stream. Specifically, a process of processing a video transport stream may include a process of identifying a video transport stream received from a server, a process of decoding the identified video transport stream, and/or a process of reproducing the decoded video transport stream. At this time, the device may automatically transform a quality level of video to be adaptive to a network condition. For example, in case the device has a small bandwidth, the device may reproduce video at a low quality level that uses a small bandwidth.

According to the present disclosure, b including metadata containing image skip-related information in a video transport stream itself, the device may skip an image section without separately requesting image skip-related information to a separate server. Specifically, when the device plays back the video according to the video transport stream, the device may automatically skip a specific image section based on image skip-related information contained in metadata which is included in the video transport stream.

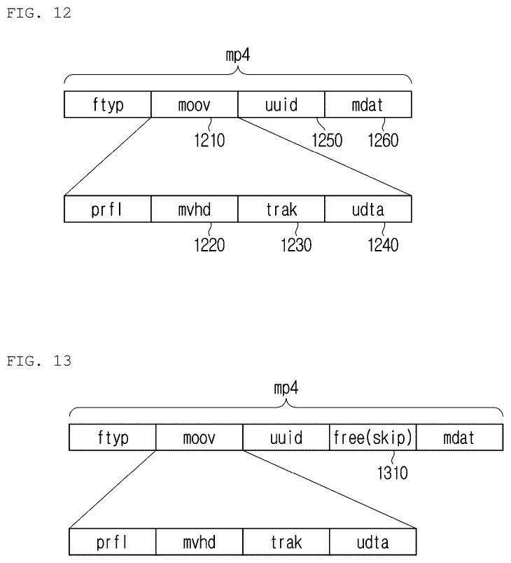

FIG. 11 illustrates a flowchart of a procedure of skipping an image section in a client device according to an embodiment of the present disclosure. An operating subject of FIG. 11 (i.e., an apparatus that performs the operation of FIG. 11) may be the client device 750. In the description below, the operating subject of FIG. 11 will be referred to as ‘client’ or ‘device’.

Referring to FIG. 11, at step S1101, a device may identify image section skip information. Specifically, when a client performs an operation associated with image section skip in response to UX guide information, the device may identify image section skip information. The image section skip information may be included in a video transport stream received from a server. Alternatively, the image section skip information may be included in metadata in the video transport stream.

An operation associated with image section skip according to the present disclosure may be performed via a user input, such as pressing or touching a button disposed in the user interface. For example, the operation to perform image section skip may be, for example, pressing an opening skip button exposed in an user interface, pressing an ending skip button exposed in an user interface, pressing a next episode view button exposed in an user interface, pressing a skip suggestive scene button exposed in the user interface, pressing a violent scene skip button exposed in the user interface, and/or pressing a horror-inducing scene skip button exposed in the user interface. The client may perform various operations corresponding to UX guide information.

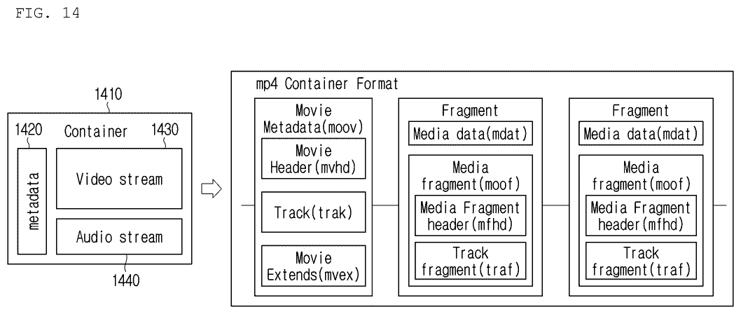

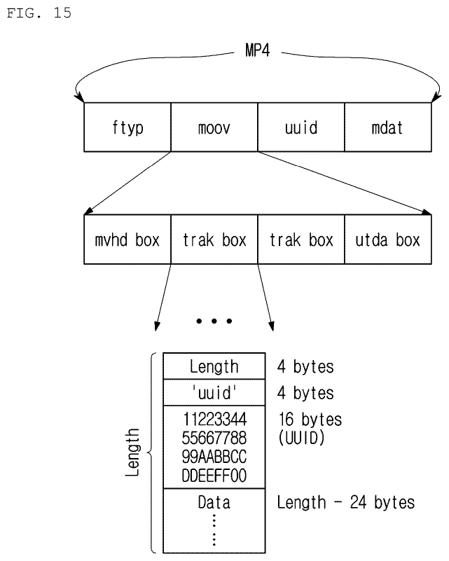

At step S1102, the device may skip an image section according to the operation to perform image section skip. In response to the image section skip information identified at step S1101, the device may skip a corresponding image section. Herein, the image section skip information may include image section type information and/or information on each image section type. A further detailed embodiment will be described using FIG. 12 and FIG. 13 below.

Image skip-related information according to an embodiment of the present disclosure may include image section skip information and/or UX guide information. Herein, the image section skip information may include one of image section type information and information on each image section type. The image section type information may include information regarding what type or kind of an image a specific image section belongs to. For example, the image section type information may include type information indicating an opening (producer logo, commercial, synopsis of a previous episode), current episode, credits (ending credit, synopsis of a next episode), and the like. The image section type information may also include information indicating an intro, a teaser, a prologue, an opening, a synopsis, a main part, a bridge, a summary, an epilogue, an ending, and/or an outro. The image section type information may further include an identifier for distinguishing information of each image section type. In this case, each image section type may be distinguished using an identifier. In other words, each image section type may be assigned an identifier (image section type identifier) and the image section type information included in the image section skip information may be identifiers corresponding to the types of the image sections that the user intends to skip. Each image may be assigned with an image section type.

Information on each image section type according to an embodiment of the present disclosure may include information on a criterion for distinguishing image section types. For example, information on each image section type may be one of time information, section duration information, offset (byte) information, and data size (byte) information. Herein, time information may include a time position value of a start point or a time position value of an end point. In addition, section duration information may include information on a time duration of a specific image section. In addition, offset information may include a data position value (e.g., address value) of a start time, and data size information may include information on a data size (e.g., byte size) of a specific image section. Without being limited thereto, information on each image section type may be information based on an identifier of a fragment (or segment). For example, it may include an identifier of a start fragment (or segment) of an image section and information indicating a difference between an identifier of a last fragment (or segment) and the start fragment (or segment).

According to an embodiment of the present disclosure, in order to skip an image section in a client device, image section skip information contained in the metadata in a video transport stream may be used.

For example, a client device may identify image section type information that is a part of the image section skip information. In case the image section type information is type information indicating ‘opening’, the client device may identify information on each image section type associated with ‘opening’. In case the information on each image section type includes information on ‘start time position value (e.g., 120)’ of an opening and an opening ‘section duration (e.g., 20)’, the client device may skip a corresponding section (e.g., section 120 to 140) by applying the start time position value and the section duration. Herein, the unit may be ms, but without being limited thereto, and may be various units. A unit may be determined in advance, but without being limited thereto, may be determined when unit information is received from metadata (e.g., data of a tkhd box).

As another example, the client device may identify image section type information that is one of image section information. In case the image section type information is type information indicating ‘ending’, the client device may identify information on each image section type associated with ‘ending’. In case the information on each image section type includes offset information of an ending section, the client device may skip the section by using the offset information.

As another example, the client device may identify image section type information that is one of image section skip information. In case the image section type information is type information indicating ‘synopsis of a previous episode’, the client device may identify information on each image section type associated with ‘synopsis of the previous episode’. In case the information on each image section type includes information on ‘start time position value’ and ‘end time position value’ of the synopsis of the previous episode, the client device may skip a corresponding section by using the information.

According to an embodiment, the client may receive a user input indicating an image section type that the user intends to skip in a video transport stream. Then, the client may skip a certain portion of the video transport stream based on the identifier of the image section type and information on the image section type corresponding to the user input.

According to an embodiment of the present disclosure, a client may preset to skip a specific section before image reproduction or during image reproduction. That is, the client may be set to skip a specific image section type before image reproduction or during image reproduction. Herein, the image section type may include an opening (producer logo, commercial, synopsis of a previous episode), current episode, credits (ending credit, synopsis of a next episode), and the like. For example, the client may set to skip an opening before image reproduction or during image reproduction. When the client sets to skip the opening, a client device may skip the opening section when reproducing the image. As another example, the client may set to skip an ending credit before image reproduction or during image reproduction. When the client sets to skip the ending credit, the client device may skip the ending credit section when reproducing the image. In this case, the client device may skip the ending credit and reproduce a next image.

The client may use a separate setting interface in order to skip a specific image section type according to the present disclosure. That is, the client may display a list of image section types and receives a user input to preset an image section type to be skipped in a separate setting interface. At this time, the client may set to skip one or more image section types. For example, the client may set to skip an opening, a commercial and an ending credit for a specific image. In this case, when reproducing the image, even if the client does not perform any separate operation, the client device may skip the opening, the commercial and the ending credit for reproduction. By pre-setting the image section to be automatically skipped, the client may achieve the effect of not having to repeat the section skip operation for each image.

According to one embodiment of the present disclosure, the client device may use user information to skip a specific section before or during video playback. That is, the client device may skip a specific image section type before or during video playback based on the user information.

Here, the user information may include age information, mental health information, psychological information, and/or payment service information. The image section type may include sexually suggestive scenes, violent scenes, horror-inducing scenes, anxiety-inducing scenes, drug-depicting scenes, drinking-depicting scenes, swearing scenes, scenes that induce negative emotions, scenes t that undermine moral values, advertisement scenes, and/or commercial scenes, and the like. For example, the client device may skip sexually suggestive scenes, violent scenes, and/or horror-inducing scenes before or during video playback based on the age information. For another example, the client device may skip anxiety-inducing scenes and/or scenes that induce negative emotions before or during video playback based on the mental health information. For another example, the client device may skip advertisement scenes and/or commercial scenes before or during video playback based on the payment service information.

The client device may automatically skip specific video sections based on the user information, such that the client may achieve the effect of automatically skipping scenes that are inappropriate for viewing. This function may be referred to as user information-based automatic skipping.

For such functionality, the client may store a correspondence table between user information and image section type information. The correspondence table may include image section types that are going to be automatically skipped according to the user information.

In case the client device performs the user information-based automatic skipping, the client may identify an image type and a section in metadata received from a server and automatically skip a section.

According to an embodiment, UX guide information according to the present disclosure may include whether or not to automatically skip a section, whether or not to expose a skip button, a location of a skip button (e.g., x, y coordinates), and/or content-dependent UI/UX-related information (e.g., item display position, display time, URL, etc.). For example, the UX guide information may include whether or not to automatically skip an ending, whether or not to automatically skip an opening, whether or not to expose an ending skip button, whether or not to expose a next episode view button, and/or whether or not to expose an opening skip button. The UX guide information may include where and how long to display those buttons. UX guide information may be included in a moov box, a uuid box, a mdat box, a free box, a udta box, an mvhd box, a trak box, a tkhd box, an mdhd box, an hdlr box, a vmhd box, an stsd box, and an avcc box in a video transport stream, and the present disclosure is not limited thereto.

According to an embodiment, the client may provide a user interface where the client receives a user input to selectively enable or disable the automatic skipping for each of the image section types. When the user information-based automatic skipping is enabled, an operation of identifying UX-related information (e.g., UX guide information) may be skipped because no user interruption is needed.

According to an embodiment of the present disclosure, when a client performs an image section skip-related operation in response to UX guide information, a client device may skip an image section. Specifically, the client device may receive UX guide information present in a video transport stream from the server. The client device may perform a relevant operation according to the received UX guide information. For example, the client device may identify a skip button location (x, y coordinates), which is a part of the UX guide information in the video transport stream, and display the skip button on a corresponding coordinate. The client may skip an image section by selecting the skip button displayed in an interface of the client device.

As another example, the client device may identify information regarding whether or not to expose an opening skip button, which is a part of UX guide information in a video transport stream. In case the information indicates exposure of the opening skip button, the client device may expose the opening skip button on the user interface. As another example, the client device may identify information regarding whether or not to expose (e.g., display) an ending skip button, which is a part of the UX guide information in the video transport stream. In case the information indicates exposure of the ending skip button, the client device may expose the ending skip button on the user interface.

As another example, the client device may identify information regarding whether or not to expose a next episode view button, which is a part of the UX guide information in the video transport stream. In case the information indicates exposure of the next episode view button, the client device may expose the next episode view button in an interface.

As another example, the client device may check the information about whether or not to automatically skip a section among the UX guide information included in the video transport stream. In case the information indicates automatic skipping of a specific section is enabled, the client device may automatically skip the section without asking an intention of a client (i.e., without receiving a separate input from the user). As a specific example, the client device may identify information regarding whether or not to automate an ending/opening skip, which is one of UX guide information in a video transport stream. In case the information indicates automatic skipping of an ending/opening, the client device may automatically skip an ending/opening section without asking an intention of a client.

As another specific example, the client device may check the information about whether age-restricted scenes are automatically skipped, which is a part of the UX guide information included in the video transport stream. In case the information indicates automatic skipping of scenes that do not match the user's age, the client device may automatically skip age-restricted scenes, such as sexually suggestive scenes, violent scenes, and/or horror-inducing scenes, without asking an intention of a client. Since the client device automatically skips a specific section based on the information about whether section skip is automatically skipped, which is a part of the UX guide information included in the video transport stream, the client does not have to perform a separate action to skip the section, and may easily avoid scenes that are inappropriate for viewing.

FIG. 12 to FIG. 13 illustrate a structure of an mp4 file according to an embodiment of the present disclosure. According to an embodiment of the present disclosure, image section skip information may be included in a moov box 1210 in a video transport stream. In particular, the image section skip information may be included in one of an mvhd box 1220, a trak box 1230, and a udta box 1240 within the moov box 1210.

According to another embodiment of the present disclosure, the image section skip information may be included as metadata in a uuid box 1250 in a video transport stream. Herein, the uuid box may be a container supporting private extension. According to yet another embodiment of the present disclosure, the image section skip information may be included as metadata in an mdat box 1260 in a video transport stream. According to yet another embodiment of the present disclosure, the image section skip information may be included as metadata in a free (skip) box 1310 in a video transport stream. As the free (skip) box 1310 ignores parsing, information necessary for restoration may be put into the free (skip) box 1310 and be used in restoration.

The locations of a uuid box and a free (skip) box are not limited to the illustrated ones in FIG. 12 and FIG. 13, but they may be located in a moov box or in a trak box. In addition, the location of a udta box is not limited to the illustrated ones in FIG. 12 and FIG. 13, but the udta box may be present in a location equivalent to a moov box, a uuid box, and an mdat box, or may be located in a sub-box of a trak box. That is, uuid, free (skip) and udta boxes may be located in a sub-data box of a specific data box or be present in a location equivalent to the specific data box. The specific data box may be a box in a fixed location such as a moov box and a trak box but is not limited thereto, and the location of the specific data box may also be variable. Information on each image section type according to the present disclosure may be defined in an elst box of the trak box 1230.

In addition, information on each image section type may be included in an mvhd box, a tkhd box, an mdhd box, an hdlr box, a vmdh box, a stsd box, and an avcc (AVC specification).

According to an embodiment, the UX guide information according to the present disclosure may be included in the mvhd box 1220, the udta box 1240, and a tkhd box within a video transport stream, but the present disclosure is not limited thereto.

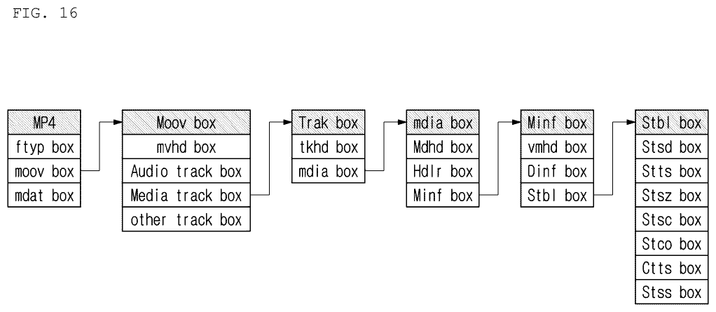

FIG. 14 illustrates a basic structure of an mp4 file according to an embodiment of the present disclosure. Referring to FIG. 14, an mp4 file may be configured as a container 1410. The container may include metadata 1420, a video stream 1430 and/or an audio stream 1440. Herein, the video stream 1430 and the audio stream 1440 may be data that are compressed through a codec. The metadata 1420 within the container 1410 may include a variety of information for controlling the video stream 1430 and/or the audio stream 1440 that are compressed through the codec. As for a further detailed structure of the mp4 file, the metadata 1420 may be present in a moov box in the mp4 container. In addition, the video stream 1430 and/or the audio stream 1440 may be divided into one or more fragments. A fragment may be a fragmented image file for image streaming.

FIG. 15 illustrates a structure of an mp4 file and boxes according to an embodiment of the present disclosure. An mp4 file may include ftyp, moov, uuid, and mdat boxes. Herein, the ftyp box may be a file type box that identifies compatibility of a file. The moov box may mean a movie box that stores all the metadata of media. The uuid box may be a universally unique identifier box including image-related metadata. The mdat box may mean a media data box storing data that are actually encoded. The moov box may include sub-boxes such as an mvhd box, one or more trak boxes, and a udta box. Herein, the mvhd box may be a movie header box including image information. The trak box may be a track box that stores metadata of specific media. The udta box may be a user data box including user information. A minimum size of each box may be 8 bytes, of which first 4 bytes may designate a size of a box, and the next 4 bytes may designate a type of the box. The uuid box may include 16-byte data separately indicating uuid, but this may not be included in a box that is not a uuid box.

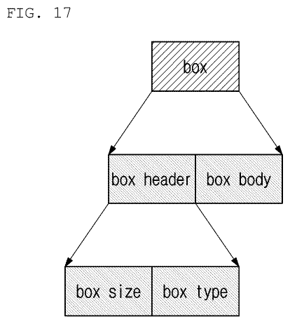

FIG. 16 illustrates one example of a box structure in a specific mp4 file according to an embodiment of the present disclosure. The mp4 file may be composed of ftyp, moov and mdat boxes, and the moov box may further be composed of an mvhd box and one or more trak boxes. Herein, the trak box may include an audio trak box and a media trak box. The trak box may be composed of a tkhd (track header) box, and an mdia box, and the mdia box may be composed of an mdhd (media header) box, an hdlr (handler) box, and an minf (media information) box. Herein, the minf box may include information for obtaining media information and a location of sample data, and the minf box may further be composed of a vmhd (media information header) box, a dinf (data information) box, and a stbl (sample table) box. The stbl box may be composed of a stsd (sample description) box, a stts (time to sample) box, a stsz (sample size) box, a stsc (sample to chunk), a stco (chunk offset) box, a ctts (composition offset) box, and a stss (sync sample) box. The above-description structure of the mp4 file is merely one embodiment, and the present disclosure is not limited thereto and may include various boxes.

FIG. 17 illustrates a basic structure of a box according to an embodiment of the present disclosure. A box may be composed of a box header and/or a box body. A box header may include information on a size (length) of a box and information on a box type. Information on a size (length) of a box and information on a box type may be represented by 4 bytes respectively. A box body may include image data. For example, it may include a video stream or an audio stream.

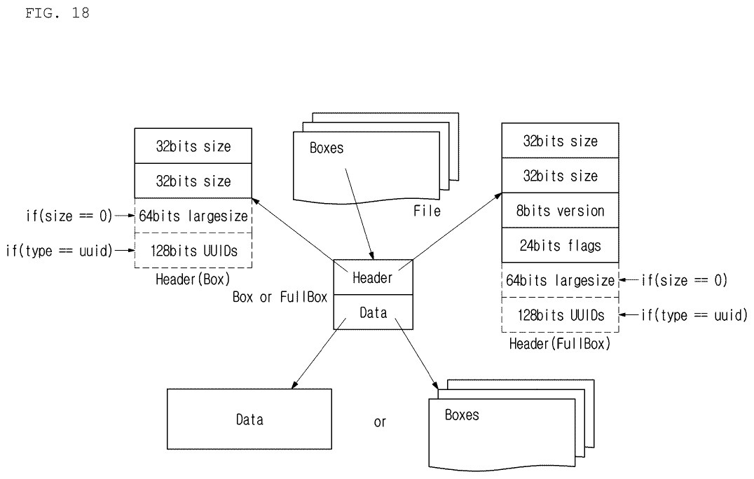

FIG. 18 illustrates a detailed structure of a box according to an embodiment of the present disclosure. A mp4 file includes one or more boxes, and a box may be composed of a header box and a data box. A header box may be configured by at least 8 bytes (32 bits), and its length may increase according to additional data. In addition, a data box may include data. Alternatively, a data box may further include one or more sub-data boxes.

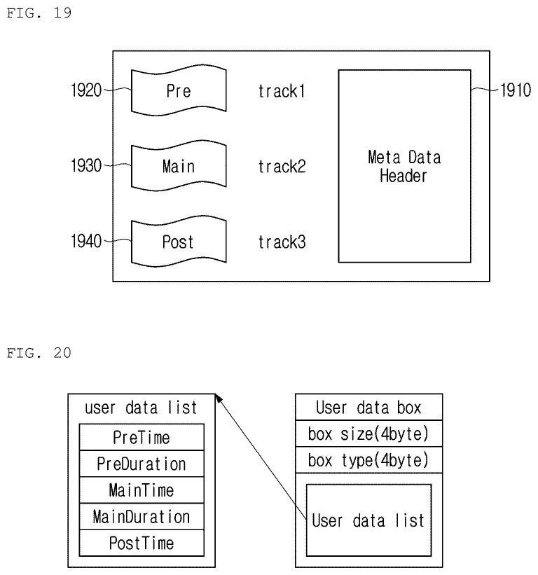

FIG. 19 illustrates a structure of a moov box according to an embodiment of the present disclosure. A moov box may be composed of a mvhd (metadata header) box 1910 and one or more track boxes 1920, 1930 and 1940. Fragmented images may be distinguished by a track box. For example, fragmented images may be distinguished by dividing a pre part as track1, a main part as track2, and a post part as track3. Each of the track boxes 1920, 1930 and 1940 may be distinguished by an identifier included in a tkhd box in a track box. In addition, each of the track boxes 1920, 1930 and 1940 may include a tkhd box, a mdhd box, and a stsd box, and separate information may be included in boxes such as the tkhd box, the mdhd box, and the stsd box. For example, such boxes as the tkhd box, the mdhd box and the stsd box may include information regarding what image section information is included in a corresponding track.

FIG. 20 illustrates a structure of a udta box according to an embodiment of the present disclosure. The udta box may include a user data list, and the user data list may include a variety of information. For example, it may include information necessary to divide an image into a pre part, a main part and a post part. That is, it may include information on time and section duration of each part (e.g., PreTime, PreDuration, MainTime, MainDuration, PostTime, etc.).

For example, a user data list may include information on time and section duration of each part. Alternatively, the user data list may include one or more sub-boxes (e.g., User data list box), and each box may include information on time and section duration of each part. A sub-box may include image section type information (box type information) and include information on each image section type corresponding to a box type. Without being limited thereto, a user data list may include information on time and section duration of every part without a separate sub-box.

Without being limited thereto, a user data list may include UX guide information, and when the UX guide information is included in a sub-box, box type information may indicate a UX guide, and the sub-box may include detailed UX guide information corresponding to a box type.

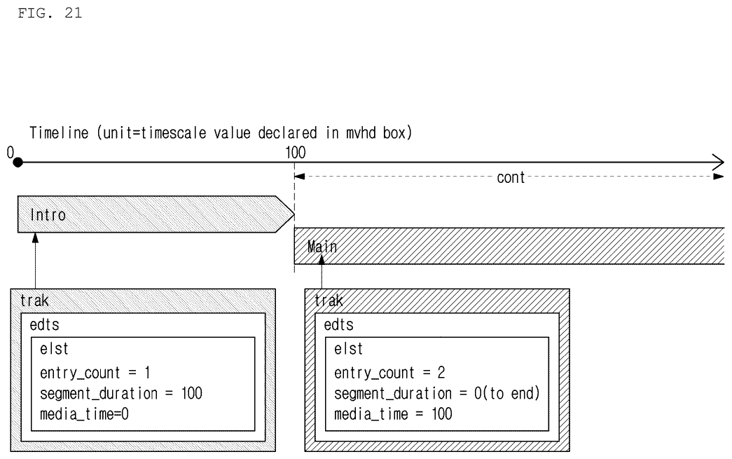

FIG. 21 illustrates a structure of information according to each image section type in a video transport stream according to an embodiment of the present disclosure. Referring to FIG. 21, image sections may be composed of one or more trak boxes. One or more trak boxes may include an edts box, and the edts box may include an elst box again. The elst box may include information associated with image sections. For example, the elst box may include information on an entry count (entry_count), section duration information (segment_duration), and section start time information (media_time). Herein, time-related information may be expressed by a location value. For example, when section duration information is 0 (to end) and section start time information is 100, the section may mean a section from the time location value of 100 to the end. Herein, a time-related unit may be a time scale value declared in a mvhd box.

According to an embodiment of the present disclosure, a client device may store a specific image by downloading the specific image. In this case, the client device may reproduce the downloaded image in an environment without Internet connection. Particularly, according to the present disclosure, because a video transport stream includes metadata including image skip-related information on its own, the client device may skip a specific section in the downloaded image even in an environment without Internet connection.

The exemplary methods of the present disclosure are represented in a series of operations for clarity of description, but this is not intended to limit the order in which the steps are performed, and each step may be performed simultaneously or in a different order, if necessary. In order to realize a method according to the present disclosure, the steps illustrated may include further other steps, or may include the remaining steps with the exception of some steps, or may include additional other steps with the exception of some steps.

Various embodiments of the present disclosure are not intended to enumerate all possible combinations, but to describe a representative aspect of the present disclosure, and the matters described in the various embodiments may be applied independently or in combination of two or more.

In addition, various embodiments of the present disclosure may be realized by hardware, firmware, software, or a combination thereof. In the case of hardware realization, the embodiments may be realized by one or more ASICs (Application Specific Integrated Circuits), DSPs (Digital Signal Processors), DSPDs (Digital Signal Processing Digital Signal Processing Devices (DSPs), Programmable Logic Devices (PLDs), Field Programmable Gate Arrays (FPGAs), general processors, controllers, microcontrollers, microprocessors, etc.

The scope of the present disclosure includes software or machine-executable commands (e. g., operating systems, applications, firmware, programs, etc.) that allow an operation according to a method of various embodiments to be performed on a device or computer, and a non-transitory computer-readable medium in which such software or commands are stored and executed on the device or computer.

Also, it is noted that any one feature of an embodiment of the present disclosure described in the specification may be applied to another embodiment of the present disclosure. Similarly, the present invention encompasses any embodiment that combines features of one embodiment and features of another embodiment.

What is claimed is:

1. A computer-implemented method for operating a server in a contents streaming system, the method comprising:
receiving image request information from a client device;
identifying a video transport stream corresponding to the image request information; and
transmitting the video transport stream to the client device,
wherein the video transport stream includes metadata including image skip-related information.

2. The computer-implemented method of claim 1, wherein the image skip-related information is included in at least one of an initialization segment (IS) or a media segment (MS) in the video transport stream.

3. The computer-implemented method of claim 1, wherein the image skip-related information includes at least one of image section skip information or user experience (UX) guide information, and
wherein the image section skip information includes at least one of image section type information indicating a type of an image section or information on each image section type indicating information on a boundary of an image section.

4. The computer-implemented method of claim 3, wherein the information on each image section type includes at least one of time information, section duration information, offset information, or data size information,
wherein the UX guide information includes information indicating at least one of whether or not to automatically skip an ending, whether or not to automatically skip an opening, whether or not to expose an ending skip button, whether or not to expose a next episode view button, whether or not to expose an opening skip button, or location information of at least one of the ending skip button, the next episode view button, or the opening skip button, and
wherein the metadata further includes information indicating at least one of an item display location, an item display time, a display section duration, and a uniform resource locator (url).

5. The computer-implemented method of claim 1, wherein the metadata including the image skip-related information is included in one metadata box among a moov box, a uuid box, a mdat box, a free box, a udta box, a mvhd box, a trak box, a tkhd box, a mdhd box, a hdlr box, a vmhd box, a stsd box, or an avcc box.

6. The computer-implemented method of claim 1, wherein the image request information includes only a request for a video transport stream itself, not including a separate request for metadata from the request for the video transport stream.

7. A computer-implemented method for operating a client device in a contents streaming system, the method comprising:
transmitting image request information to a server;
receiving a video transport stream corresponding to the image request information; and
processing the video transport stream,
wherein the video transport stream includes metadata including the image skip-related information.

8. The computer-implemented method of claim 7, wherein the image skip-related information is included in at least one of an initialization segment (IS) or a media segment (MS) in the video transport stream.

9. The computer-implemented method of claim 7, wherein the image skip-related information includes at least one of image section skip information or user experience (UX) guide information, and
wherein the image section skip information includes at least one of image section type information indicating a type of an image section or information on each image section type indicating information on a boundary of an image section.

10. The computer-implemented method of claim 9, wherein the information on each image section type includes at least one of time information, segment duration information, offset information, or data size information,
wherein the UX guide information includes information indicating at least one of whether or not to automatically skip an ending, whether or not to automatically skip an opening, whether or not to expose an ending skip button, whether or not to expose a next episode view button, whether or not to expose an opening skip button, or location information ofat least one of the ending skip button, the next episode view button, or the opening skip button, and
wherein the metadata further includes information indicating at least one of an item display location, an item display time, a display section duration, or a uniform resource locator (url).

11. The computer-implemented method of claim 9, wherein the method for operating the client device further comprises:
identifying the UX guide information; and
displaying a user interface corresponding to the identified UX guide information on the client device.

12. The computer-implemented method of claim 7, wherein the metadata including the image skip-related information is included in one metadata box among a moov box, a uuid box, a mdat box, a free box, a udta box, a mvhd box, a trak box, a tkhd box, a mdhd box, a hdlr box, a vmhd box, a stsd box, or an avcc box.

13. The computer-implemented method of claim 7, wherein the processing of the video transport stream comprises:
identifying the video transport stream;
decoding the identified video transport stream; and
reproducing the decoded video transport stream.

14. The computer-implemented method of claim 7, further comprising:
identifying metadata including image section skip information in the video transport stream; and
skipping an image section corresponding to the image section skip information,
wherein the image skip-related information includes at least one of the image section skip information or user experience (UX) guide information, and
wherein the image section skip information includes at least one of image section type information indicating a type of an image section or information on each image section type indicating information on a boundary of an image section.

15. The computer-implemented method of claim 7, further comprising:
while reproducing the video transport stream, automatically skipping a portion of the video transport stream based on the image skip-related information contained in the metadata included.

16. The computer-implemented method of claim 7, further comprising:
analyzing age information of a user stored in a memory of the client device; and
while reproducing the video transport stream, automatically skipping a portion of the video transport stream based on the image skip-related information contained in the metadata included and the age information of the user.

17. The computer-implemented method of claim 7, further comprising:
analyzing an identifier of a preset to-be-skipped image section type stored in a memory of the client device; and
while reproducing the video transport stream, automatically skipping a portion of the video transport stream based on the image skip-related information contained in the metadata included and the identifier of a preset to-be-skipped image section type stored in the memory of the client device.

18. A device for transmitting a video transport steam in a contents streaming system, the device comprising:
a memory configured to store information necessary for operating the device; and
a processor coupled with the memory,
wherein the processor is configured to:
receive image request information from a client device,
identify a video transport stream corresponding to the image request information, and
transmit the video transport stream to the client device, and
wherein the video transport stream includes metadata including image skip-related information.
